(19) United States
(12) Patent Application Publication
(10) Pub. No.: US 2026/0278232 A1
(43) Pub. Date: Sep. 17, 2026

(54) METHOD OF GENERATING LAYOUT OF SEMICONDUCTOR DEVICE, STORAGE MEDIUM, AND SEMICONDUCTOR DEVICE

(71) Applicant: Kioxia Corporation, Tokyo (JP)

(72) Inventor: Kazuhiro ODA, Yokohama Kanagawa (JP)

(73) Assignee: Kioxia Corporation, Tokyo (JP)

(21) Appl. No.: 19/235,278

(22) Filed: Jun. 11, 2025

(30) Foreign Application Priority Data
Mar. 14, 2025 (JP) 2025-041529

(51) Int. Cl. G06F 30/392; G06F 119/06; G06F 119/08; H10D 64/27

(52) U.S. Cl. CPC G06F 30/392; H10D 64/519; G06F 2119/06; G06F 2119/08

(57) ABSTRACT

A method of generating a layout of a semiconductor device including at least one transistor according to one embodiment includes: performing a simulation of an amount of current per finger in an operation of the semiconductor device for the each transistor; calculating an amount of change in temperature corresponding to a result of the simulation for the each transistor based on a relationship between the amount of current per finger of the transistor and the amount of change in the temperature of the transistor; and inserting not less than one dummy transistor for the each transistor in a case where the calculated amount of change in temperature does not satisfy a limiting condition on the amount of change in temperature.

### CROSS-REFERENCE TO RELATED APPLICATIONS

This application is based upon and claims the benefit of priority from Japanese Patent Application No. 2025-041529, filed Mar. 14, 2025, the entire contents of which are incorporated herein by reference.

### FIELD

Embodiments described herein relate generally to a method of generating the layout of a semiconductor device, a program, and a semiconductor device.

### BACKGROUND

A transistor including a gate having a plurality of fingers is known.

### BRIEF DESCRIPTION OF THE DRAWINGS

FIG. 1 is a view showing an example of the arrangement of a semiconductor device according to the first embodiment.

FIG. 2 is a sectional view showing an example of the structure of a transistor of the semiconductor device according to the first embodiment.

FIG. 3 is a sectional view showing an example of the structure of a transistor of the semiconductor device according to the first embodiment.

FIG. 4 is a sectional view showing an example of the structure of a transistor of the semiconductor device according to the first embodiment.

FIG. 5 is a sectional view showing an example of the structure of a transistor of the semiconductor device according to the first embodiment.

FIG. 6 is a sectional view showing an example of the structure of a transistor of the semiconductor device according to the first embodiment.

FIG. 7 is a sectional view showing an example of the structure of a transistor of the semiconductor device according to the first embodiment.

FIG. 8 is a block diagram showing an example of the arrangement of a computer used to generate the layout of the semiconductor device according to the first embodiment. FIG. 9 is a graph showing an example of information stored in the SHE (self heating effect) database of the computer according to the first embodiment.

FIG. 10 is a flowchart showing an example of a method of generating the layout of a semiconductor device according to the first embodiment.

FIG. 11 is a view showing the first example of the planar layout of the semiconductor device according to the first embodiment.

FIG. 12 is a view showing the second example of the planar layout of the semiconductor device according to the first embodiment.

FIG. 13 is a view showing an example of the arrangement of a semiconductor device according to the second embodiment.

FIG. 14 is a flowchart showing an example of a method of generating the layout of the semiconductor device according to the second embodiment.

FIG. 15 is a view showing the first example of the planar layout of the semiconductor device according to the second embodiment.

FIG. 16 is a view showing the second example of the planar layout of the semiconductor device according to the second embodiment.

### DETAILED DESCRIPTION

In general, according to one embodiment, a method of generating the layout of a semiconductor device includes generating the layout of a semiconductor device including at least one transistor. The method includes performing a simulation of an amount of current per finger in an operation of the semiconductor device for the each transistor, calculating an amount of change in temperature corresponding to a result of the simulation based on a database storing information indicating a relationship between the amount of current per finger of the transistor and the amount of change in the temperature of the transistor, and inserting not less than one dummy transistor if the calculated amount of change in temperature does not satisfy a limiting condition on the amount of change in temperature.

Each embodiment will be described below with reference to the accompanying drawings. Each embodiment exemplifies a device and a method which embody the technical idea of the present invention. The drawings are schematic or conceptual. The dimensions and ratios of each drawing are not always the same as the actual ones. Illustrations of some components are omitted as needed. The hatchings added to the plan views are not necessarily associated with the materials and characteristics of constituent elements. In this specification, the same reference numerals are assigned to constituent elements having almost the same functions and configurations. The numbers and letters added to reference numerals are referred to by the same reference numerals and are used to discriminate similar elements from each other.

### <1> First Embodiment

The first embodiment relates to a method of generating a dummy FET (field-effect transistor) to suppress a deterioration in the performance of a transistor TR such as an field-effect transistor (FET) due to self-heating effect (SHE) at the time of generating the layout of a semiconductor device 10 including the transistor TR and the semiconductor device 10 generated by using the method. The first embodiment will be described in detail below.

### <1-1> Arrangement

The arrangement of the semiconductor device 10 according to the first embodiment will be described first.

### <1-1-1> Arrangement of Semiconductor Device 10

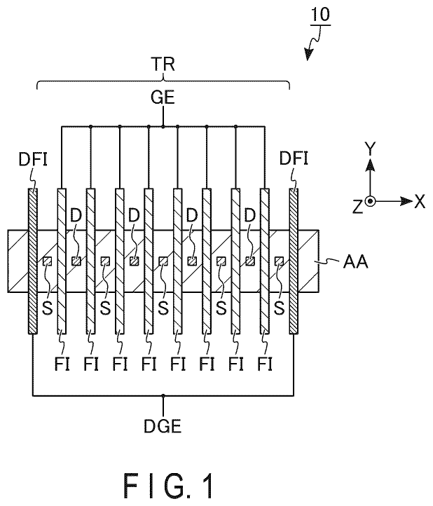

FIG. 1 is a view showing an example of the arrangement of the semiconductor device 10 according to the first embodiment. FIG. 1 exemplarily shows the arrangement associated with the one transistor TR included in the semiconductor device 10. As shown in FIG. 1, the semiconductor device 10 includes an active area AA and a plurality of fingers FI associated with the transistor TR.

The active area AA is a semiconductor area formed on a semiconductor substrate. In this example, the active area AA has a portion provided to extend in the X direction. The type of impurity contained in the active area AA is based on the conductivity type of the transistor TR formed by using the active area AA. For example, the active area AA of an N-channel metal-oxide-semiconductor field-effect transistor (MOSFET) contains a P-type impurity such as boron. The active area AA of a P-channel MOSFET contains an N-type impurity such as phosphorus.

In this example, the transistor TR is provided with eight fingers FI. The eight fingers FI correspond to a gate electrode GE of the transistor TR. Each finger FI has a portion provided to extend in the Y direction and intersects the active area AA in plan view. In addition, in the example, the eight fingers FI are arranged in the X direction. The areas delimited by the fingers FI in the active area AA function as sources S or drains D of the transistor TR. The portions of the active area AA which function as the sources S or the drains D of the transistor TR can further include impurity diffusion areas corresponding to the conductivity type of the transistor TR.

The semiconductor device 10 can further include a plurality of dummy fingers DFI. For example, in the semiconductor device 10, the two dummy fingers DFI are arranged to sandwich the eight fingers in the X direction. The dummy fingers DFI are provided at intervals equal to those of the plurality of fingers FI arranged in the X direction and used as auxiliary patterns at the time of forming the plurality of fingers FI. The two dummy fingers DFI correspond to a gate electrode DGE of a dummy transistor (dummy FET). The dummy transistor is a transistor that has a structure similar to that of the transistor TR and is not used for the operation of the semiconductor device 10. At the time of the operation of the semiconductor device 10, a voltage that sets the dummy transistor in an OFF state is applied to the gate electrode DGE of the dummy transistor. Accordingly, at the time of the operation of the semiconductor device 10, no current or a very small current as compared with the transistor TR is made to flow in the dummy transistor. The potential of the gate electrode DGE of the dummy transistor is set to the same potential as the bulk.

Note that the number of fingers FI of the transistor TR is not limited to eight and can be changed according to the required performance of the transistor TR. For example, the respective fingers FI constituting the transistors TR of the same type are designed to have the same size. The placement of the dummy fingers DFI is not limited to the two ends of the transistor TR. The plurality of transistors TR may be formed in the single active area AA. In such a case, the number of fingers FI may differ for each transistor TR. In addition, a dummy transistor (the dummy finger DFI) may be inserted in an area where the transistor TR is formed to suppress the amount of change in temperature at the time of the operation of the transistor TR. A specific example of the insertion position of the dummy transistor in the transistor TR will be described later.

### <1-1-2> Structure of Transistor TR

The first, second, and third examples of the structures of the transistors TR of the semiconductor device 10 according to the first embodiment will be sequentially described next. The transistors TR of the first, second, and third examples are respectively referred to as transistors TRa, TRb, and TRc.

### First Example

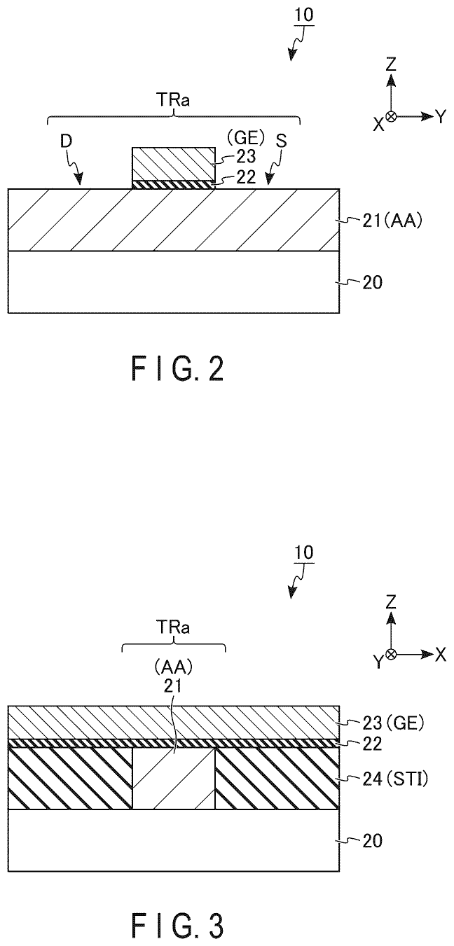

FIGS. 2 and 3 are sectional views showing an example of the structure of the transistor TRa of the semiconductor device 10 according to the first embodiment. FIG. 2 shows a cross-section of the transistor TRa along the extending direction of the channel (Y direction). FIG. 3 shows a cross-section of the transistor TRa in a direction (the X direction) intersecting the extending direction of the channel. The transistor TRa is a planar type MOSFET. As shown in FIGS. 2 and 3, the semiconductor device 10 includes, for example, a semiconductor substrate 20, a semiconductor layer 21, an insulator layer 22, a conductor layer 23, and an insulating member 24.

The semiconductor layer 21 is provided on the semiconductor substrate 20. The semiconductor layer 21 has a portion provided to extend in the X direction and functions as the active area AA. That is, part of the semiconductor layer 21 functions as the channel of the transistor TRa. A side surface of the semiconductor layer 21 is provided with the insulating member 24. The insulating member 24 functions as an STI (Shallow Trench Isolation) and insulates between the adjacent active areas AA (not shown). The insulator layer 22 is provided on the semiconductor layer 21. The insulator layer 22 functions as the gate insulating film of the transistor TRa. The conductor layer 23 is provided on the insulator layer 22. The conductor layer 23 functions as one finger FI (the gate electrode GE) of the transistor TRa. In this example, a combination of the insulator layer 22 and the conductor layer 23 has a portion provided to extend in the X direction. As described above, in the transistor TRa, one surface of the semiconductor layer 31 corresponding to the channel faces the gate electrode GE through the insulator layer 22.

Note that the semiconductor layer 21 can have an impurity diffusion area in a portion corresponding to the drain D or the source S of the transistor TRa. Contacts can be respectively connected to the two impurity diffusion areas corresponding to the drain D and the source S and the conductor layer 23. If the transistor TR includes the plurality of fingers FI, combinations of the insulator layers 22 and the conductor layers 23 are arranged in the Y direction. In the transistor TRa, the plurality of conductor layers 23 corresponding to the plurality of fingers FI are electrically connected to each other.

### Second Example

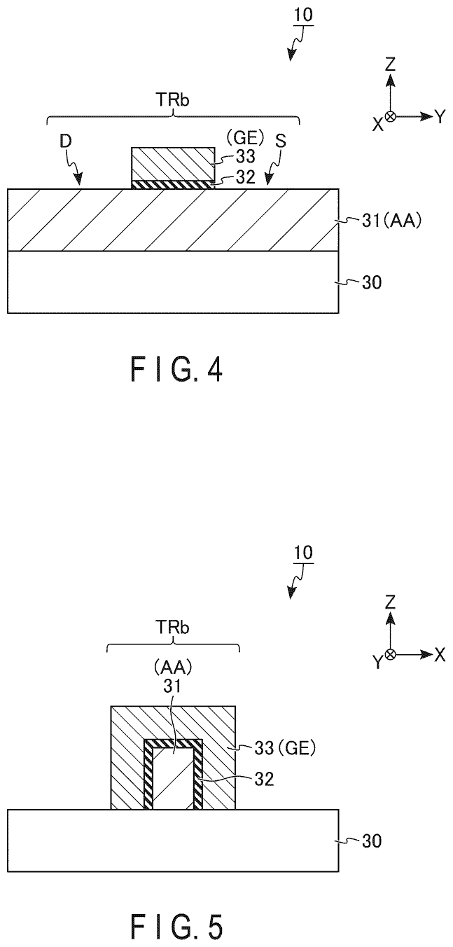

FIGS. 4 and 5 are sectional views showing an example of the structure of the transistor TRb of the semiconductor device 10 according to the first embodiment. FIG. 4 shows a cross-section of the transistor TRb along the extending direction (the Y direction) of the channel. FIG. 5 shows a cross-section of the transistor TRb in a direction (the X direction) intersecting the extending direction of the channel. The transistor TRb is a fin field-effect transistor (FinFET). As shown in FIGS. 4 and 5, the semiconductor device 10 includes, for example, a semiconductor substrate 30, a semiconductor layer 31, an insulator layer 32, and a conductor layer 33.

The semiconductor layer 31 is provided on the semiconductor substrate 20. The semiconductor layer 31 has a portion provided to extend in the X direction and functions as the active area AA. That is, part of the semiconductor layer 31 functions as the channel of the transistor TRb. The insulator layer 32 is provided to cover portions of the upper surface and a side surface of the semiconductor layer 31. The insulator layer 32 functions as the gate insulating film of the transistor TRb. The conductor layer 33 is provided to cover the upper surface and the side surface of the insulator layer 32. The conductor layer 33 functions as one finger FI (the gate electrode GE) of the transistor TRb. As described above, in the transistor TRb, the three surfaces of the semiconductor layer 31 corresponding to the channel face the gate electrode GE through the insulator layer 32.

Note that the semiconductor layer 31 can have an impurity diffusion area in a portion corresponding to the drain D or the source S of the transistor TRb. Contacts can be respectively connected to the two impurity diffusion areas corresponding to the drain D and the source S and the conductor layer 33. If the transistor TRb has the plurality of fingers FI, combinations of the insulator layers 32 and the conductor layers 33 are arranged in the Y direction. In the transistor TRb, the plurality of conductor layers 33 corresponding to the plurality of fingers FI are electrically connected to each other.

### Third Example

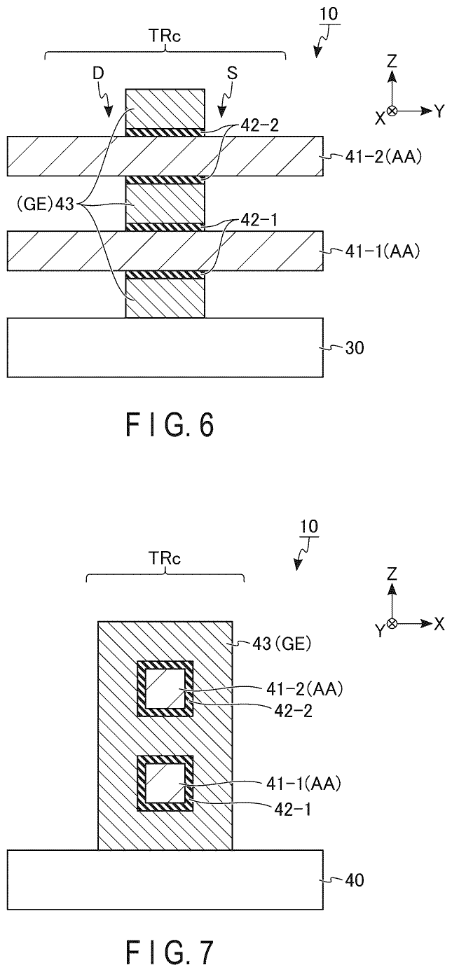

FIGS. 6 and 7 are sectional views showing an example of the structure of the transistor TRc of the semiconductor device 10 according to the first embodiment. FIG. 6 shows a cross-section of the transistor TRc along the extending direction (the Y direction) of the channel. FIG. 7 shows a cross-section of the transistor TRc in a direction (the X direction) intersecting the extending direction of the channel. The transistor TRc is a gate-all-around (GAA) type FET. As shown in FIGS. 6 and 7, the semiconductor device 10 includes, for example, a semiconductor substrate 40, semiconductor layers 41-1 and 41-2, insulator layers 42-1 and 42-2, and a conductor layer 43.

The semiconductor layers 41-1 and 41-2 are provided in the Z direction above the semiconductor substrate 20. Each of the semiconductor layers 41-1 and 41-2 has a portion extending in the X direction and functions as the active area AA. That is, part of each of the semiconductor layers 41-1 and 41-2 functions as a channel of the transistor TRc. The insulator layers 42-1 and 42-2 are provided to respectively annularly cover the semiconductor layers 41-1 and 41-2. The insulator layers 42-1 and 42-2 each function as a gate insulating film of the transistor TRc. The conductor layer 43 is provided to cover the upper surfaces, side surfaces, and bottom surfaces of the insulator layers 42-1 and 42-2. The conductor layer 43 functions as one finger FI (the gate electrode GE) of the transistor TRc. As described above, in the transistor TRc, the four surfaces of the semiconductor layers 41 corresponding to the channels face the gate electrodes GE through the insulator layers 42.

Note that each of the semiconductor layers 41-1 and 41-2 can have an impurity diffusion area in a portion corresponding to the drain D or the source S of the transistor TRb. Contacts can be respectively connected to the two impurity diffusion areas corresponding to the drain D and the source S and the conductor layer 43. The GAA type FET may have at least one combination of the semiconductor layer 41 and the insulator layer 42 for each gate electrode GE (conductor layer 43). If the transistor TRc includes the plurality of fingers FI, combinations of the insulator layers 42 and the conductor layers 43 are arranged in the Y direction. In the transistor TRc, the plurality of conductor layers 43 corresponding to the plurality of fingers FI are electrically connected to each other.

### <1-1-3> Arrangement of Processing Apparatus 50

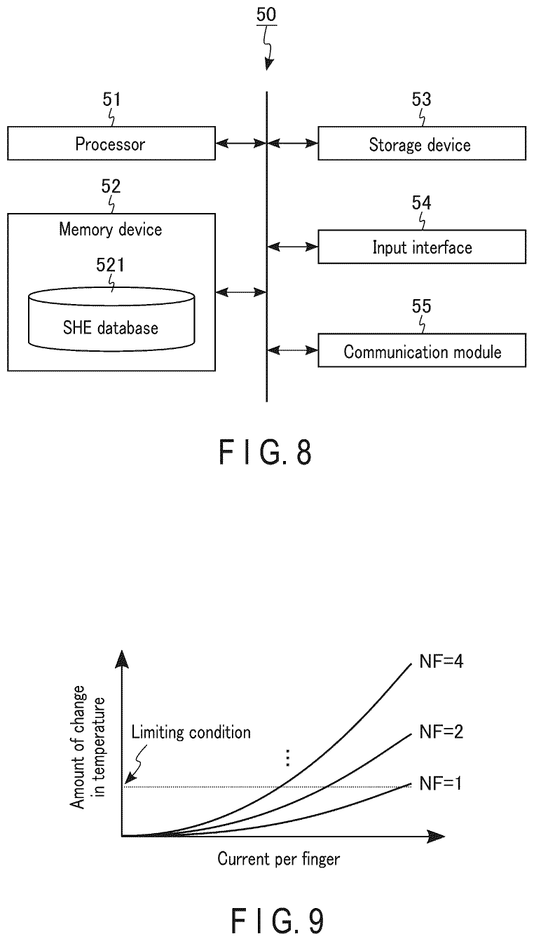

An example of the arrangement of a processing apparatus 50 (computer) used to design the layout of the semiconductor device 10 according to the first embodiment will be described next. FIG. 8 is a block diagram showing an example of the arrangement of the processing apparatus 50 used to design the layout of the semiconductor device 10 according to the first embodiment. As shown in FIG. 8, the processing apparatus 50 includes, for example, a processor 51, a memory device 52, a storage device 53, an input interface 54, and a communication module 55.

The processor 51 is an integrated circuit that can execute various programs and controls the overall operation of the processing apparatus 50. As the processor 51, for example, a central processing unit (CPU), micro processing unit (MPU), application specific integrated circuit (ASIC), field-programmable gate array (FPGA), or graphics processing unit (GPU) is used.

The memory device 52 is a storage device that stores programs, control data, and the like for controlling the processing apparatus 50. The memory device 52 can be used as the work area of the processor 51. Note that the processing apparatus 50 may separately include a memory device that stores programs and control data and a memory device used as the work area of the processor 51.

The storage device 53 is a nonvolatile storage device. The storage device 53 stores, for example, application software and system software for the processing apparatus 50. As the storage device 53, for example, a solid state drive (SSD) or hard disk drive (HDD) is used.

The input interface 54 is an interface used to operate the processing apparatus 50. The user can operate the processing apparatus 50 by using the input interface 54. The processing apparatus 50 may be configured such that a function as the input interface 54 is incorporated in a display device externally connected to the processing apparatus 50.

The communication module 55 is a circuit used for the transmission and reception of data and the like to and from external devices. Either wired communication or wireless communication may be used for the transmission and reception of data and the like by the communication module 55. The communication module 55 may be connected to an external storage device or to an external server via a network NW.

The processing apparatus 50 described above is configured to generate the planar layout of the semiconductor device 10 (more specifically, the layout of each transistor TR) by using, for example, a SHE database 521 stored in the memory device 52. The SHE database 521 includes information concerning the characteristics of the self heating effect (SHE) of the transistor TR. The processing apparatus 50 can calculate the amount of change in the temperature of the transistor TR from the layout shape of the semiconductor device 10 and the amount of current per the finger FI by using the SHE database 521.

FIG. 9 is a graph showing an example of the information stored in the self heating effect (SHE) database 521 of the processing apparatus 50 according to the first embodiment. In the graph shown in FIG. 9, the abscissa represents the amount of current per the finger FI, and the ordinate represents the amount of change in the temperature of the transistor TR. “NF” represents the number of fingers FI included in the transistor TR.

As shown in FIG. 9, as the amount of current per the finger FI increases, the amount of change in the temperature of the transistor TR increases. That is, the temperature of the transistor TR increases. As the number of fingers FI increases, the amount of change in temperature with respect to the amount of current per the finger FI increases. The broken line in FIG. 9 exemplarily shows a limiting condition on the amount of change in temperature. The limiting condition on the amount of change in temperature is set to enable the transistor TR to implement required performance. Note that the limiting condition on the amount of change in temperature may differ in accordance with the type of element, the number of fingers FI, and the like. A limiting condition on the amount of change in temperature is set to enable the transistor TR to have required performance even if a rise in temperature is caused by SHE.

### <1-2> Method

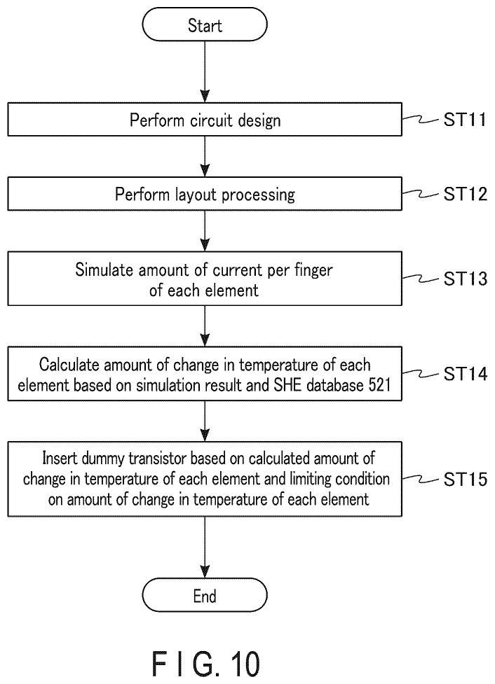

An example of a method of generating the layout of the semiconductor device 10 according to the first embodiment will be described next with reference to FIG. 10. FIG. 10 is a flowchart showing an example of the method of generating the layout of the semiconductor device 10 according to the first embodiment. Each process to be described below is executed by, for example, the processor 51 of the processing apparatus 50.

First of all, circuit design for the formation of the semiconductor device 10 is performed (step ST11). In circuit design, the number of fingers FI and the like are determined in accordance with the required performance of the transistor TR. The processing apparatus 50 then executes the layout processing of roughly determining the placement of the respective transistors TR of the semiconductor device 10 (step ST12). The processing apparatus 50 performs the simulation of the amount of current per the finger FI of each element (transistor TR) (step ST13). Thereafter, the processing apparatus 50 calculates the amount of change in the temperature of each element (transistor TR) based on the simulation result obtained in step ST13 and the information stored in the SHE database 521 (step ST14). The processing apparatus 50 inserts a dummy transistor based on the calculated amount of change in the temperature of each element (transistor TR) and a limiting condition on the amount of change in the temperature of each element (step ST15). More specifically, if the amount of change in the temperature of the transistor TR does not meet the limiting condition on the amount of change in temperature, the processing apparatus 50 inserts one or more dummy transistors in the transistor TR.

As described above, the processing apparatus 50 according to the first embodiment automatically generates a dummy transistor (the dummy finger DFI) based on the amount of current per the finger FI and the strength of limitation on the amount of change in the temperature of each element. The processing apparatus 50 then can change the number or placement of dummy transistors to be generated based on the amount of current per the finger FI and a limiting condition on the amount of change in temperature. For example, the number of dummy transistors inserted in the transistor TR is set to increase with an increase in the amount of current per finger calculated by simulation. In addition, the number of dummy transistors to be inserted in the transistor TR is set to increase as the strength of the limiting condition on the amount of change in temperature increases.

The first and second examples of the planar layout of the semiconductor device 10 which is generated by the processing apparatus 50 according to the first embodiment will be sequentially described below.

### First Example

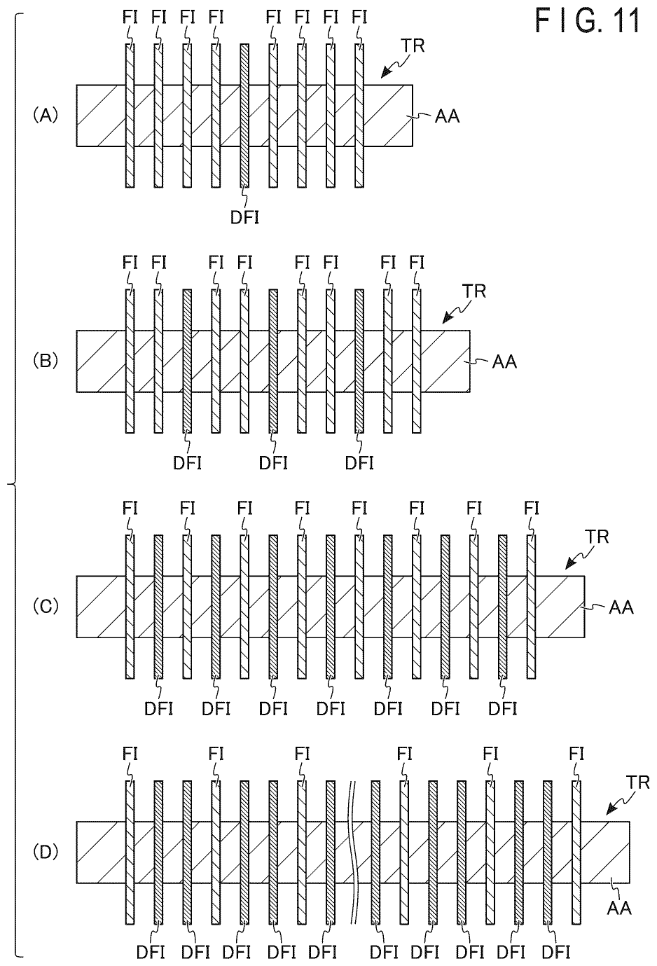

FIG. 11 is a view showing the first example of the planar layout of the semiconductor device 10 according to the first embodiment. In FIG. 11, (A), (B), (C), and (D) each exemplarily show a case where at least one dummy transistor (the dummy finger DFI) is inserted in the transistor TR having the eight fingers FI based on the amount of current per the finger FI and the limiting condition on the amount of change in temperature. The layouts of the transistor TR indicated by (A), (B), (C), and (D) in FIG. 11 are arranged in the increasing order of the amount of current per the finger FI or the increasing order to the strength of a limiting condition on the amount of change in temperature from the upper side to the lower side of the drawing surface.

If the amount of current per the finger FI is the first value and/or the limiting condition on the amount of change in temperature is the first condition, one dummy finger DFI is inserted in the transistor TR as indicated by, for example, (A) in FIG. 11. For example, one dummy finger DFI is placed at a position that is set by equally dividing the plurality of fingers FI of the transistor TR. In other words, in this example, one dummy finger DFI is inserted every four fingers FI of the plurality of fingers FI arranged in the X direction.

If the amount of current per the finger FI is the second value larger than the first value and/or the limiting condition on the amount of change in temperature is the second condition higher in strength than the first condition, one dummy finger DFI is inserted every two fingers FI of the plurality of fingers FI arranged in the X direction, as indicated by, for example, (B) in FIG. 11.

If the amount of current per the finger FI is the third value larger than the second value and/or the limiting condition on the amount of change in temperature is the third condition higher in strength than the second condition, one dummy finger DFI is inserted every one finger FI of the plurality of fingers FI arranged in the X direction, as indicated by, for example, (C) in FIG. 11.

If the amount of current per the finger FI is the fourth value larger than the third value and/or the limiting condition on the amount of change in temperature is the fourth condition higher in strength than the third condition, two dummy fingers DFI are inserted every one finger FI of the plurality of fingers FI arranged in the X direction, as indicated by, for example, (D) in FIG. 11.

### Second Example

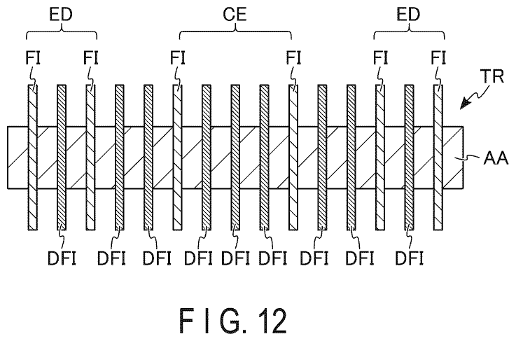

FIG. 12 is a view showing the second example of the planar layout of the semiconductor device 10 according to the first embodiment. FIG. 12 exemplarily shows a case where a plurality of dummy transistors (the dummy fingers DFI) are inserted in the transistor TR having the six fingers FI based on the amount of current per the finger FI and the limiting condition on the amount of change in temperature. As shown in FIG. 12, in this example, the density of dummy transistors (the dummy fingers DFI) arranged in a central portion CE of the transistor TR is higher than the density of dummy transistors (the dummy fingers DFI) arranged in each end portion ED of the transistor TR. In this manner, by the processing apparatus 50, the dummy fingers DFI may be inserted in the transistor TR such that the number of dummy fingers DFI arranged in the central portion CE of the transistor TR is larger than the number of dummy fingers DFI arranged in each end portion ED of the transistor TR.

The amount of rise in the temperature of the transistor TR due to SHE is based on the sum of ambient power consumptions. Accordingly, the processing apparatus 50 can suppress a rise in temperature due to SHE at the central portion CE where the temperature tends to rise by arranging the dummy fingers DFI as in FIG. 12. The processing apparatus 50 may be configured such that if the amount of current per the finger FI is larger than a predetermined value and/or the limiting condition on the amount of change in temperature is stronger than a predetermined condition, the dummy fingers DFI are inserted as shown in FIG. 12.

### <1-3> Advantageous Effects of First Embodiment

If the amount of heat in the transistor TR due to SHE increases, the required performance may not be implemented due to characteristic degradation. If SHE check is performed after the completion of the layout of the semiconductor device 10, a large loss occurs due to backtracking processing upon detection of a problem. For example, in backtracking processing, the placement of the elements in the layout is changed or the amount of current per element is reduced (for example, the number of elements is increased) at the stage of circuit design.

Accordingly, at the stage of circuit design, it is preferable to consider the amount of change in temperature of the transistor TR due to SHE. As a method of suppressing the amount of change in the temperature of the transistor TR, it is conceivable to increase the interval between the two adjacent fingers FI by inserting the dummy finger DFI (dummy transistor) in the plurality of fingers FI of the transistor TR.

In the method of generating the layout of the semiconductor device 10 according to the first embodiment, therefore, when the layout of the transistor TR is designed, dummy transistors are inserted as needed to satisfy the limiting condition on the amount of change in temperature based on the simulation result of the amount of current per the finger FI and the SHE database 521. In other words, the method of generating the layout of the semiconductor device 10 according to the first embodiment is configured such that dummy transistors are automatically inserted as needed in order to decrease the amount of change in the temperature of the transistor TR.

As a consequence, in the method of generating the layout of the semiconductor device 10 according to the first embodiment, the amount of change in the temperature of the transistor TR automatically decreases to an amount lower than the limiting condition upon occurrence of an element in the layout of the semiconductor device 10, thereby reducing the occurrence of a situation in which backtracking processing is required based on inspection after the completion of the layout. Accordingly, the method of generating the layout of the semiconductor device 10 according to the first embodiment can suppress the manufacturing cost of the semiconductor device 10.

The method of generating the layout of the transistor TR described in the first embodiment is effective as the amount of heat generated due to SHE increases. More specifically, a FinFET is larger in the amount of heat generated due to SHE than a planar type FET. In addition, a GAA type FET is larger in the amount of heat generated due to SHE than a FinFET. This is because the portion covered with the gate electrode GE increases in area in the order of a planar type FET, a FinFET, and a GAA type FET, resulting in structures with more difficulty in releasing heat. For this reason, the effect obtained by inserting a dummy transistor (the dummy finger DFI) using the method described in the first embodiment is larger in a FinFET than in a planar type FET and larger in a GAA type FET than in a FinFET.

### <2> Second Embodiment

A method of generating the layout of a semiconductor device 10A according to the second embodiment is configured to generate a dummy transistor (dummy FET) based on the amount of current per a finger FI of each element when performing abutment for two elements (transistor TR). The second embodiment will be described below focusing on differences from the first embodiment.

### <2-1> Arrangement

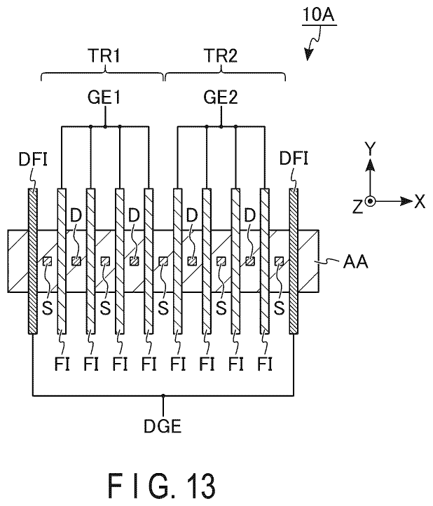

FIG. 13 is a view showing an example of the arrangement of the semiconductor device 10A according to the second embodiment. FIG. 13 exemplarily shows an arrangement associated with two transistors TR1 and TR2 included in the semiconductor device 10A. As shown in FIG. 13, the semiconductor device 10A includes, for example, an active area AA and a plurality of fingers FI associated with the two transistors TR1 and TR2.

In this example, each of the transistors TR1 and TR2 is provided with four fingers FI. The four fingers FI associated with the transistor TR1 correspond to a gate electrode GE1 of the transistor TR1. The four fingers FI associated with the transistor TR2 correspond to a gate electrode GE2 of the transistor TR2. Each finger FI has a portion provided to extend in the Y direction and intersects the active area AA in plan view. In this example, the four fingers FI corresponding to the transistor TR1 and the four fingers FI corresponding to the transistor TR2 are arranged in the X direction. In the active area AA, the area delimited by the fingers FI functions as a source S or a drain D of the transistor TR1 or TR2.

In this manner, in the semiconductor device 10A, the plurality of transistors TR1 and TR2 are formed by using the same active area AA. The transistors TR1 and TR2 can share the source S or the drain D in the portion sandwiched between the transistors TR1 and TR2 in plan view. Note that the semiconductor device 10A can include a plurality of dummy fingers DFI as in the first embodiment. The two dummy fingers DFI shown in FIG. 13 correspond to a gate electrode DGE of a dummy transistor (dummy FET). The number of fingers FI of each transistor TR is not limited to eight and can be changed in accordance with the required performance of the transistor TR.

### <2-2> Method

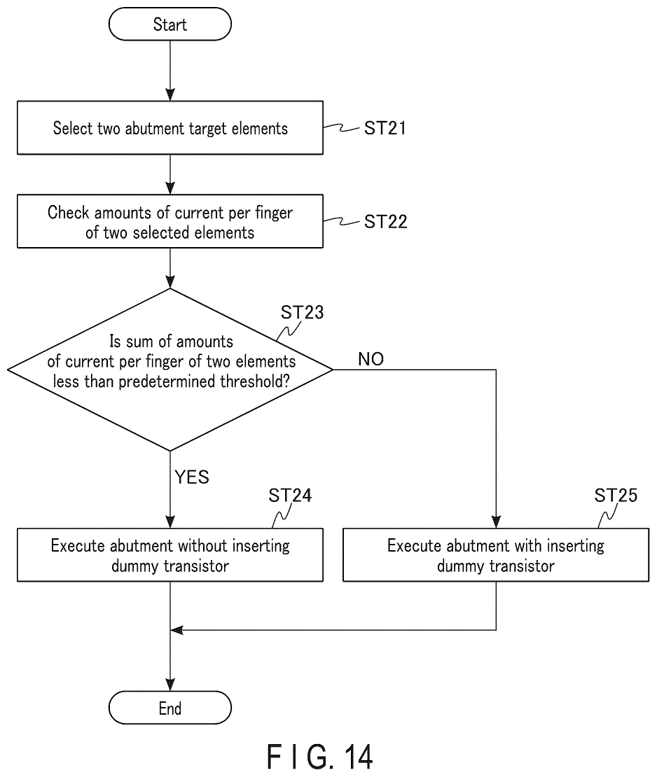

An example of a method of generating the layout of the semiconductor device 10A according to the second embodiment will be described next with reference to FIG. 14. FIG. 14 is a flowchart showing an example of the method of generating the layout of a semiconductor device according to the second embodiment. Each process described below is executed by, for example, a processor 51 of a processing apparatus 50. In addition, each process is executed after, for example, the method of generating the layout of the semiconductor device 10 described in the first embodiment is executed.

First of all, the processing apparatus 50 selects two abutment target elements (the transistors TR) (step ST21). The processing apparatus 50 then checks the amount of current per the finger FI of each of the two selected elements (step ST22). In step ST22, for example, a simulation result similar to that in step ST13 shown in FIG. 10 is used. The processing apparatus 50 checks, for example, whether the sum of the amounts of current per the finger FI of two elements is less than a predetermined threshold (step ST23).

If the sum of the amounts of current per the finger FI of two elements is less than the predetermined threshold (step ST23: YES), the processing apparatus 50 executes abutment without inserting any dummy transistors (step ST24). That is, in the processing apparatus 50, the two elements (the transistors TR1 and TR2) share the active area AA and are arranged adjacent to each other without through any dummy transistors.

If the sum of the amounts of current per the finger FI of two elements is not less than the predetermined threshold (equal to or more than the predetermined threshold) (step ST23: NO), the processing apparatus 50 executes abutment with inserting a dummy transistor (step ST25). That is, in the processing apparatus 50, the two elements (the transistors TR1 and TR2) share the active area AA and are arranged adjacent to each other through at least one dummy transistor.

As described above, the processing apparatus 50 according to the second embodiment determines whether a dummy transistor is inserted based on the amount of current per the finger FI of each element when performing abutment for the two elements. Note that the processing apparatus 50 may change the number of dummy transistors to be generated based on the amount of current per the finger FI and the limiting condition on the amount of change in temperature.

In addition, the processing apparatus 50 may use other determination conditions in the processing in step ST23. For example, the processing apparatus 50 determines whether a dummy transistor (the dummy finger DFI) is inserted between the transistors TR1 and TR2 in accordance with the number of dummy transistors (the dummy fingers DFI) inserted in each of the two abutment target transistors TR1 and TR2. For example, the processing apparatus 50 can be configured to insert the dummy transistor between the transistor TR1 and the transistor TR2 in performing abutment for the transistor TR1 and the transistor TR2 if the number of dummy transistors inserted in the transistor TR1 is equal to or more than the first value and the number of dummy transistors inserted in the transistor TR2 is equal to or more than the second value. In this example, the first value and the second value may be the same or different. If, for example, the number of fingers FI in the transistor TR1 is different from that in the transistor TR2, the first value and the second value are set to different values.

The first and second examples of the planar layout of the semiconductor device 10A generated by the processing apparatus 50 according to the second embodiment will be sequentially described below.

### First Example

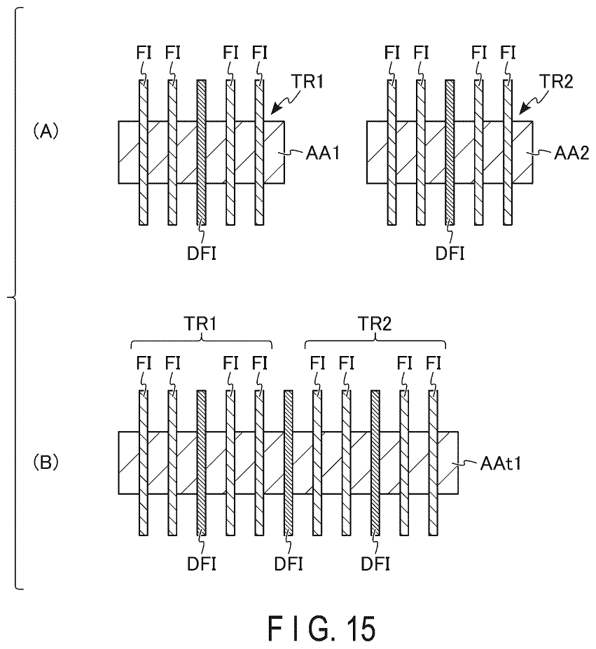

FIG. 15 is a view showing the first example of the planar layout of the semiconductor device 10A according to the second embodiment. In FIG. 15, (A) indicates the layouts of two abutment target elements (transistors TR1 and TR2). In FIG. 15, (B) indicates the layouts of the two elements (the transistors TR1 and TR2) after abutment. In the first example, the amount of current per the finger FI of each of the transistors TR1 and TR2 is set to a large value. As indicated by (A) in FIG. 15, the dummy finger DFI is inserted in each of the transistors TR1 and TR2.

In this case, as indicated by (B) in FIG. 15, the processing apparatus 50 automatically inserts a dummy transistor (the dummy finger DFI) between the transistors TR1 and TR2 when performing abutment for the two elements (the transistors TR1 and TR2). The transistors TR1 and TR2 are configured to share an active area AAt1. As a result, the size of the active area AAt1 of the abutted transistors TR1 and TR2 is smaller than the sum of the size of an active area AA1 of the single transistor TR1 and the size of an active area AA2 of the single transistor TR2.

### Second Example

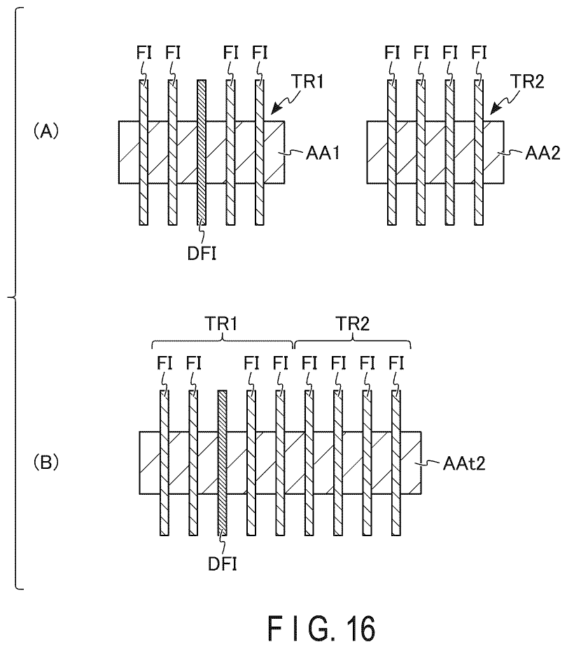

FIG. 16 is a view showing the second example of the planar layout of the semiconductor device according to the second embodiment. In FIG. 16, (A) indicates the layouts of the two abutment target elements (the transistors TR1 and TR2). In FIG. 16, (B) indicates the layout of the two elements (the transistors TR1 and TR2) after abutment. In the second example, the amount of current per the finger FI of the transistor TR1 is set to a large value, and the amount of current per the finger F2 of the transistor TR2 is set to a small value. As indicated by (A) in FIG. 16, the dummy finger DFI is inserted in only the transistor TR1.

In this case, as indicated by (B) in FIG. 16, the processing apparatus 50 does not insert a dummy transistor (the dummy finger DFI) between the transistors TR1 and TR2 when abutting the two elements (the transistors TR1 and TR2). The transistors TR1 and TR2 are configured to share an active area AAt2. As a result, the size of the active area AAt2 between the abutted transistors TR1 and TR2 is smaller than the sum of the size of an active area AA1 of the single transistor TR1 and the size of an active area AA2 of the single transistor TR2.

### <2-3> Advantageous Effects of Second Embodiment

As described above, the method of generating the layout of the semiconductor device 10A according to the second embodiment can automatically insert a dummy transistor based on the amount of current per the finger FI of the two abutment target elements and the limiting condition on the amount of change in the temperature of a transistor TR. In addition, if the limiting condition on the amount of change in temperature can be satisfied, the insertion of a dummy transistor at the time of abutment of two elements is omitted. This makes it possible to suppress the circuit area (chip area) of the semiconductor device 10A.

Accordingly, the method of generating the layout of the semiconductor device 10A according to the second embodiment can obtain advantageous effects similar to those of the first embodiment and can suppress the chip area of the semiconductor device 10A. As a result, the method of generating the layout of the semiconductor device 10A according to the second embodiment can suppress the manufacturing cost of the semiconductor device 10A.

### <3> Others

In the above embodiments, the flowcharts used for the descriptions of the operations are merely examples. The processing order of the operations described with reference to the flowcharts may be interchanged within a possible range, other processes may be added to the operations, part of the processing may be omitted, or parts of the processing may be concurrently executed. Each process described in the above embodiments may be implemented by dedicated hardware. The processing described in the above embodiments may be a mixture of the processing executed by software and the processing executed by hardware or one of them.

In the above embodiments, the processing apparatus 50 may have another arrangement. For example, the storage device 53 and the input interface 54 each may be externally connected to the processing apparatus 50. In this specification, “plan view” means that, for example, a constituent element is visually checked from above, and “visually checked” means that a target is observed with a microscope, a camera, or the like. In addition, “abutment” corresponds to the processing of making two abutment target elements share an active area when generating the layout of the semiconductor device 10A.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of generating a layout of a semiconductor device including at least one transistor, the method comprising:
performing a simulation of an amount of current per finger in an operation of the semiconductor device for the each transistor;
calculating an amount of change in temperature corresponding to a result of the simulation for the each transistor based on a relationship between the amount of current per finger of the transistor and the amount of change in the temperature of the transistor; and
inserting not less than one dummy transistor for the each transistor in a case where the calculated amount of change in temperature does not satisfy a limiting condition on the amount of change in temperature.

2. The method according to claim 1, wherein the number of dummy transistors inserted in the transistor increases as the amount of current per the finger calculated by the simulation increases.

3. The method according to claim 1, wherein the number of dummy transistors inserted in the transistor increases as strength of a limiting condition on the amount of change in temperature increases.

4. The method according to claim 1, wherein the transistor has a plurality of fingers, each having a portion extending in a first direction, arranged in a second direction intersecting the first direction and formed by using an active area, and
the dummy transistor has a dummy finger having a portion extending in the first direction and shares the active area with the transistor, the dummy finger being inserted between two adjacent fingers.

5. The method according to claim 1, further comprising inserting the dummy transistors in the transistor to make a density of the dummy transistors arranged in a central portion of the transistor become higher than a density of the dummy transistors arranged in an end portion of the transistor.

6. The method according to claim 1, further comprising inserting the dummy transistor between a first transistor and a second transistor included in the semiconductor device in a case where the number of dummy transistors inserted in the first transistor is not less than a first value, and the number of dummy transistors inserted in the second transistor is not less than a second value in abutting the first transistor and the second transistor.

7. The method according to claim 1, wherein the transistor is one of a fin field-effect transistor (FinFET) and a gate-all-around (GAA) type FET.

8. A storage medium storing a program used to generate a layout of a semiconductor device including at least one transistor, the program comprising:
performing a simulation of an amount of current per finger in an operation of the semiconductor device for the each transistor;
calculating an amount of change in temperature corresponding to a result of the simulation for the each transistor based on a relationship between the amount of current per finger of the transistor and the amount of change in the temperature of the transistor; and
inserting not less than one dummy transistor for the each transistor in a case where the calculated amount of change in temperature does not satisfy a limiting condition on the amount of change in temperature.

9. The storage medium according to claim 8, wherein the number of dummy transistors inserted in the transistor increases as the amount of current per the finger calculated by the simulation increases.

10. The storage medium according to claim 8, wherein the number of dummy transistors inserted in the transistor increases as strength of a limiting condition on the amount of change in temperature increases.

11. The storage medium according to claim 8, wherein the transistor has a plurality of fingers, each having a portion extending in a first direction, arranged in a second direction intersecting the first direction and formed by using an active area, and
the dummy transistor has a dummy finger having a portion extending in the first direction and shares the active area with the transistor, the dummy finger being inserted between two adjacent fingers.

12. The storage medium according to claim 8, wherein the program further comprises inserting the dummy transistors in the transistor to make a density of the dummy transistors arranged in a central portion of the transistor become higher than a density of the dummy transistors arranged in an end portion of the transistor.

13. The storage medium according to claim 8, wherein the program further comprises inserting the dummy transistor between a first transistor and a second transistor included in the semiconductor device in a case where the number of dummy transistors inserted in the first transistor is not less than a first value, and the number of dummy transistors inserted in the second transistor is not less than a second value in abutting the first transistor and the second transistor.

14. The storage medium according to claim 8, wherein the transistor is one of a fin field-effect transistor (FinFET) and a gate-all-around (GAA) type FET.

15. A semiconductor device comprising:
an active region;
a transistor formed by using the active area, the transistor having a plurality of fingers arranged in a first direction, and each of the plurality of fingers having a portion extending in a second direction intersecting the first direction; and
a plurality of dummy transistors that share the active area with the transistor, each of the plurality of dummy transistors being inserted between two adjacent fingers of the plurality of fingers in plan view,
wherein a density of the dummy transistors arranged in a central portion of the transistor is higher than a density of the dummy transistors arranged in an end portion of the transistor.

16. The device according to claim 15, wherein the transistor is one of a fin field-effect transistor (FinFET) and a gate-all-around (GAA) type FET.
